(19) United States
(12) Patent Application Publication
(10) Pub. No.: US 2022/0070306 A1
(43) Pub. Date: Mar. 3, 2022

(54) INFORMATION PROCESSING APPARATUS, SYSTEM, AND DISPLAY METHOD

(71) Applicant: Nanami ISHII, Kanagawa (JP)

(72) Inventor: Nanami ISHII, Kanagawa (JP)

(73) Assignee: Ricoh Company, Ltd.

(21) Appl. No.: 17/394,517

(22) Filed: Aug. 5, 2021

(30) Foreign Application Priority Data
Sep. 3, 2020 (JP) 2020-147992

(51) Int. Cl. H04N 1/00; G06F 3/12

(52) U.S. Cl. CPC H04N 1/0048; H04N 1/0049; G06F 3/1258; G06F 3/1204; G06F 3/1275; H04N 1/0044

(57) ABSTRACT

An information processing apparatus, a system, and a display method. The information processing apparatus receives a display request for displaying a settings screen to be displayed when executing an application, transmits to the server, an acquisition request for acquiring set value information of a component included in the application to be executed, receives the set value information of the component that is transmitted from the server in response to the acquisition request, and displays on a display, the settings screen including a set value compatible with the application executing in the information processing apparatus, the set value being determined based on the set value information of the information processing apparatus and the set value information of the component.

### CROSS-REFERENCE TO RELATED APPLICATIONS

This patent application is based on and claims priority pursuant to 35 U.S.C. § 119(a) to Japanese Patent Application No. 2020-147992, filed on Sep. 3, 2020, in the Japan Patent Office, the entire disclosure of which is hereby incorporated by reference herein.

### BACKGROUND

### Technical Field

The present disclosure relates to an information processing apparatus, a system, and a display method.

### Related Art

In general, an information processing apparatus such as an image forming apparatus represented by a multifunction peripheral (MFP) is provided so as to communicate with a server such as an application store.

According to a user operation, an information processing apparatus obtains an application provided by the server, executes the obtained application, and performs necessary service-related processing. When the obtained application is executed by the information processing apparatus, the service-related processing cannot be implemented by the information processing apparatus unless the information processing apparatus and the application are compatible with each other.

### SUMMARY

Embodiments of the present disclosure describe an information processing apparatus, a system, and a display method. The information processing apparatus receives a display request for displaying a settings screen to be displayed when executing an application, transmits to the server, an acquisition request for acquiring set value information of a component included in the application to be executed, receives the set value information of the component that is transmitted from the server in response to the acquisition request, and displays on a display, the settings screen including a set value compatible with the application executing in the information processing apparatus, the set value being determined based on the set value information of the information processing apparatus and the set value information of the component.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of a configuration of a network system according to embodiments of the present disclosure;

FIG. 2 is a block diagram illustrating an example of a hardware configuration of each of a service providing system, an external storage system, and a communication terminal;

FIG. 3 is a block diagram illustrating an example of a hardware configuration of a device;

FIG. 4 is a block diagram illustrating functional configurations of the device and the service providing system according to embodiments of the present disclosure;

FIG. 5 is a conceptual diagram illustrating a workflow application;

FIG. 6 is a conceptual diagram illustrating an example of an application information management table;

FIG. 7 is a conceptual diagram illustrating an example of a component information management table;

FIG. 8 is a sequence diagram illustrating an example of a display process of a settings screen on an operation panel of the device;

FIGS. 9A, 9B, and 9C are conceptual diagrams illustrating an example of corresponding original size information;

FIG. 10 is a sequence diagram illustrating another example of the display process of the settings screen on the operation panel of the device;

FIG. 11 is a diagram illustrating a display example of an application top screen on the operation panel of the device;

FIGS. 12A and 12B are diagrams illustrating display examples of the settings screens on the operation panel of the device;

FIG. 13 is a sequence diagram illustrating an example of an application process executed by designating an original size;

FIG. 14 is a conceptual diagram illustrating a display example of a completion screen on the operation panel of the device;

FIG. 15 is a sequence diagram illustrating an example of an application process executed by automatic detection without designating the original size;

FIG. 16 is a sequence diagram illustrating another example of the application process executed by automatic detection without designating the original size;

FIG. 17 is a conceptual diagram illustrating a display example of a warning screen on the operation panel of the device;

FIG. 18 is a conceptual diagram illustrating another display example of the warning screen on the operation panel of the device; and

FIG. 19 is a conceptual diagram illustrating a display example of a preview screen on the operation panel of the device.

The accompanying drawings are intended to depict embodiments of the present invention and should not be interpreted to limit the scope thereof The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

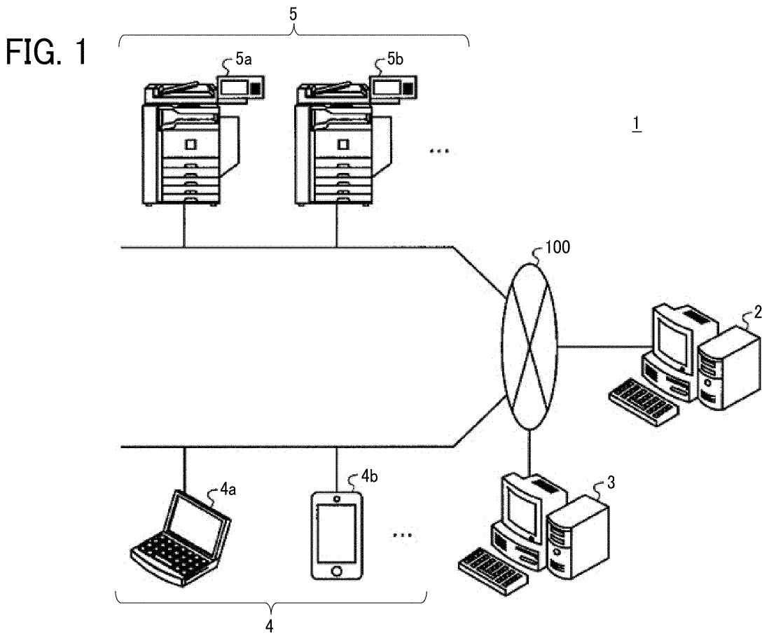

FIG. 1 is a diagram illustrating an example of a configuration of a network system according to the present embodiment.

The network system 1 includes a service providing system 2, an external storage system 3, a communication terminal 4, a device 5, and the like. The service providing system 2 provides the device 5 with services such as optical character recognition (OCR), Portable Document Format (PDF) processing, image conversion, and email transmission. The external storage system 3 provides a storage area to the communication terminal 4 and the device 5, a part of cloud service.

The service providing system 2 and the external storage system 3 each or together correspond to a server according to the present embodiment and the server may be implemented by one computer, or functions of the server may be distributed to a plurality of computers.

Examples of the communication terminal 4 include a personal computer (PC) 4a, a smartphone 4b, or the like used by a user to set a service (application) provided by the service providing system 2. The communication terminal 4 is not limited to the PC and the smartphone, and may be a mobile phone, a tablet terminal, a desktop PC, or the like.

The device 5 is an information processing apparatus provided with various functions such as print, scan, copy, and facsimile communication in order to execute a service process provided by the service providing system 2.

The device 5 corresponds to the information processing apparatus according to the present embodiment, and in FIG. 1, MFPs 5a and 5b are illustrated as examples of the device 5.

The communication terminal 4 and the device 5 may be connected to the communication network 100 to enable communication with the service providing system 2 and the external storage system 3. The communication network 100 is a local area network (LAN), the internet, or the like. The service providing system 2 manages information on various applications and processing requests from the device 5.

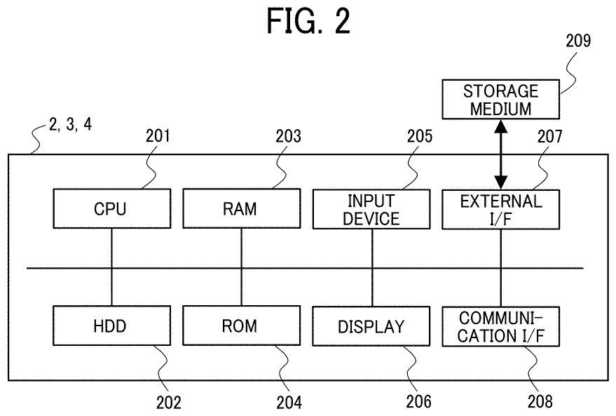

FIG. 2 is a block diagram illustrating an example of a hardware configuration of the service providing system 2, the external storage system 3, and the communication terminal 4.

Each of the system 2, 3, and the communication terminal 4 includes a central processing unit (CPU) 201, a hard disk drive (HDD) 202, a random access memory (RAM) 203, a read only memory (ROM) 204, an input device 205, a display 206, an external interface (I/F) 207, and a communication I/F 208.

The CPU 201 is an arithmetic unit for controlling the entire systems 2 and 3 or the communication terminal 4 to implement a function. The CPU 201 reads programs and data stored in the HDD 202 and the ROM 204 into the RAM 203 from the HDD 202 and the ROM 204 and executes a process.

The HDD 202 is a non-volatile storage device and stores programs and data (operating system (OS), applications, etc.). The RAM 203 is a volatile semiconductor memory, which temporarily stores programs and data. ROM 204 is a non-volatile semiconductor memory and stores programs and data (basic input/output system (BIOS), OS settings, network settings, etc.).

The input device 205 includes a keyboard, a mouse, a touch panel, and the like, and receives input from the user. The display 206 displays a processing result.

The external I/F 207 is an interface for connecting to a storage medium 209 that is an external device. The communication I/F 208 is an interface for connecting to the communication network 100. The storage medium 209 includes, for example, a flexible disk, a compact disc (CD), a digital versatile disc (DVD), a Secure Digital (SD) memory card, and a Universal Serial Bus (USB) memory.

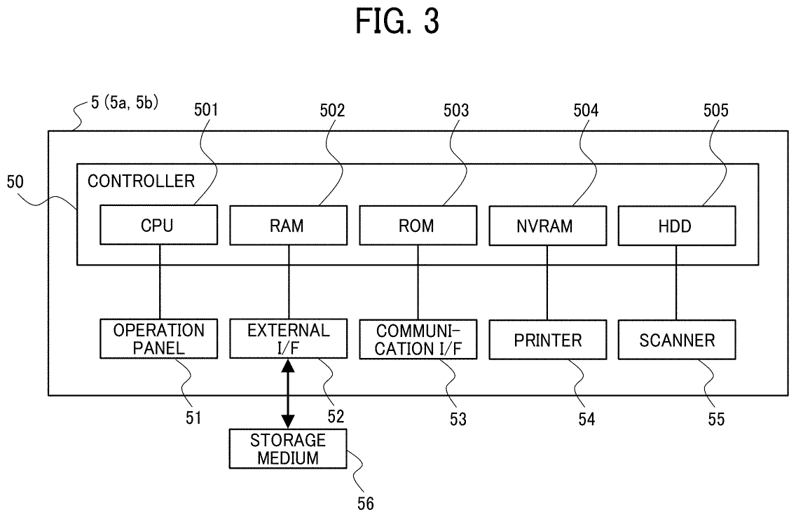

FIG. 3 is a block diagram illustrating an example of a hardware configuration of the device 5.

The MFPs 5a and 5b illustrated as examples of the device 5 each includes a controller 50, an operation panel 51, an external I/F 52, a communication I/F 53, a printer 54, and a scanner 55.

In the controller 50, a CPU 501 is an arithmetic unit that implements control and functions of the entire device 5. The CPU 501 reads a program, data, settings information, etc. from a ROM 503, a non-volatile RAM (NVRAM) 504, and an HDD 505 onto a RAM 502, and executes processes.

The RAM 502 is a volatile semiconductor memory, which temporarily stores programs and data. The ROM 503 is a nonvolatile semiconductor memory that stores programs and data. The NVRAM 504 is the nonvolatile semiconductor memory and stores settings information and the like. The HDD 505 is a nonvolatile storage device that stores programs and data.

The operation panel 51 includes an input device that receives input from the user and a display device that displays a settings screen and the like.

The external I/F 52 is an interface for connecting to a storage medium 56 that is an external device. The communication I/F 53 is an interface for connecting to the communication network 100.

The printer 54 is a printing device that prints print data, and the scanner 55 is a reading device that reads an original and generates an electronic file (image file). The storage medium 56 is an integrated circuit (IC) card, the flexible disk, the CD, the DVD, the SD memory card, the USB memory, or the like.

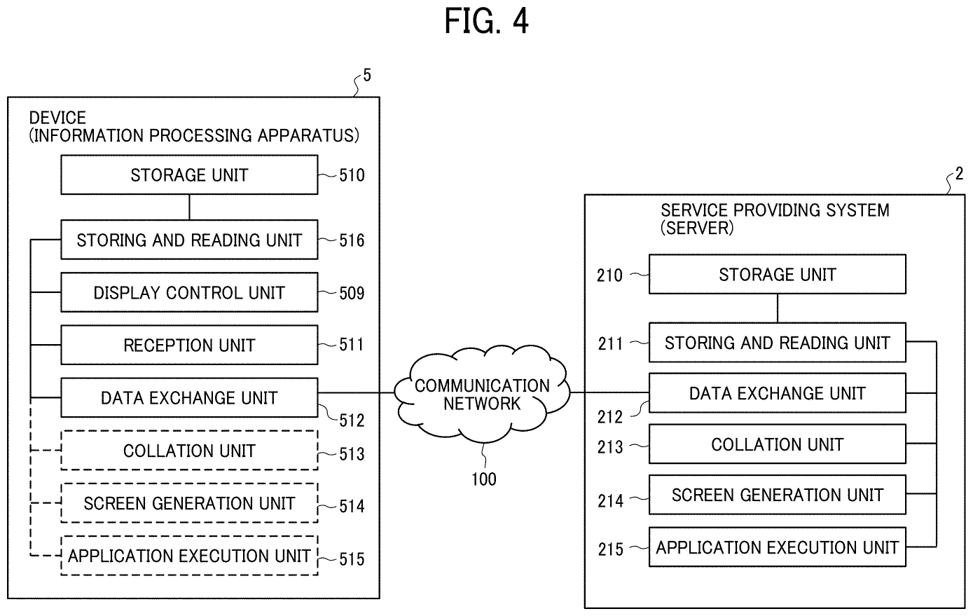

FIG. 4 is a block diagram illustrating functional configurations of the device 5 and the service providing system 2 according to the present embodiment.

The device 5 includes a display control unit 509, a storing and reading unit 516, a reception unit 511, a data exchange unit 512, a collation unit 513, a screen generation unit 514, and an application execution unit 515. These units are functions implemented by or caused to function by operating any of the elements illustrated in FIG. 3 in cooperation with the instructions of the CPU 501 according to a device program developed on the RAM 502.

Further, the device 5 includes a storage unit 510 implemented by the ROM 503, NVRAM 504, HDD 505, and the like illustrated in FIG. 3. The storage unit 510 stores device set value information indicating set value of the device 5. The device set value information is, for example, information on original size or resolution that is supported by the device 5.

The functions corresponding to the collation unit 513, the screen generation unit 514, and the application execution unit 515 may be included in the device 5 or may be included in the service providing system 2.

The display control unit 509 is mainly implemented by the processing of the CPU 501 and the operation panel 51 and causes the operation panel 51 to display various display screens such as the settings screen described below.

The storing and reading unit 516 is mainly implemented by the processing of the CPU 501 and stores various data (or information) in the storage unit 510 or reads various data (or information) from the storage unit 510.

The reception unit 511 is mainly implemented by the processing of the CPU 501 and the operation panel 51 and receives the user's input on the operation panel 51.

The data exchange unit 512 is mainly implemented by the processing of the CPU 501 and the communication I/F 53 and enables communication with the service providing system 2 through the communication network 100. The data exchange unit 512 transmits information and the like corresponding to the user request received by the reception unit 511 to the service providing system 2, and receives information transmitted from the service providing system 2.

The collation unit 513 is mainly implemented by the processing of the CPU 501, and collates application set value information indicating the set value of the application received from the service providing system 2 by the data exchange unit 512, with device set value information indicating the set value of the device 5, to extract the information on the set value supported by the current device 5. In this manner, the information on the set value supported by the current device 5 is determined. The application set value information is, for example, information on the original size or resolution supported by the application.

The screen generation unit 514 is mainly implemented by the processing of the CPU 501 and generates screen information of various screens to be displayed on the operation panel 51 based on the collation result by the collation unit 513.

The application execution unit 515 is mainly implemented by the processing of the CPU 501 and executes the service processing by the application imported into the device 5.

The service providing system 2 includes a storage unit 210, a storing and reading unit 211, a data exchange unit 212, a collation unit 213, a screen generation unit 214, and an application execution unit 215. Functions of these units are implemented by operating any of the components illustrated in FIG. 2 by the instructions from the CPU 201 according to a service providing system program developed on the RAM 203.

Further, the service providing system 2 includes a storage unit 210 implemented by the ROM 204, the HDD 202, and the like illustrated in FIG. 2. The storage unit 210 mainly stores information about a plurality of applications. The application here is not limited to an application including a single component, but includes an application including a plurality of components such as a workflow application. Details of the workflow application is described below.

The storing and reading unit 211 is mainly implemented by the processing of the CPU 201 and stores various data (or information) in the storage unit 210 or reads various data (or information) from the storage unit 210. For example, when the data exchange unit 212 receives an application information acquisition request, the storing and reading unit 211 reads application information corresponding to the received acquisition request among the application information stored in the storage unit 210.

The data exchange unit 212 is mainly implemented by processing of the CPU 201 and the communication I/F 208 and enables communication with the device 5 through the communication network 100. The data exchange unit 212 receives, for example, information transmitted from the device 5 and transmits screen information generated by the screen generation unit 214 to the device 5.

The collation unit 213 is mainly implemented by the processing of the CPU 201. The collation unit 213 collates device set value information received by the data exchange unit 212 with the application set value information including a plurality of component information acquired from the storage unit 210 and extracts the set value information available in the current device 5.

The screen generation unit 214 is mainly implemented by the processing of the CPU 201 and generates screen information of various screens to be displayed on the operation panel 51 based on the collation result of the collation unit 213.

The application execution unit 215 is mainly implemented by the processing of the CPU 201 and executes the service process by the application in response to the request from the device 5.

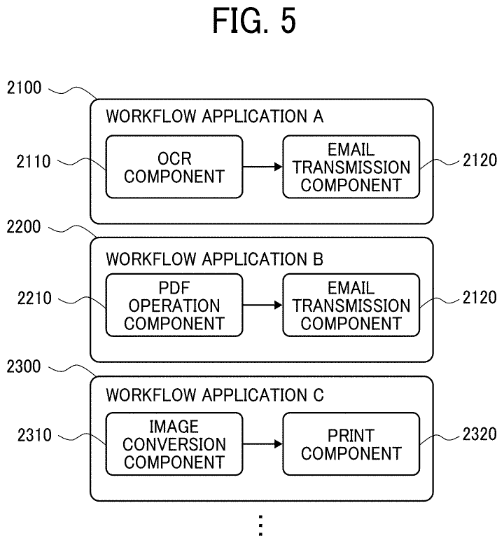

FIG. 5 is a conceptual diagram illustrating a workflow application.

The workflow application is, for example, an application configured by combining a plurality of components (functions) so that the service process can be performed according to a flow desired by a user.

The workflow application does not have to be always developed in-house but may also be developed in combination with components created by a third party such as a development partner. Therefore, even if there is only one application, the set value information (specifications) between individual components included in the application may not all match.

Therefore, in order to manage the workflow application, it is necessary to grasp the set value information for each component included in the application.

The storage unit 210 stores information on a plurality of workflow applications A, B, and C.

Each of the workflow applications A, B, and C includes a plurality of components (functions), and by freely combining the components, it is possible to obtain a unique workflow application that can execute a process in a flow desired by the user.

FIG. 5 illustrates a combination of processing components such as OCR, PDF operation and image conversion with output components such as email transmission and printing.

For example, a workflow application A includes a combination of an OCR component 2110 and an email transmission component 2120. The workflow application A is an application that executes a process of sending an email of a result after OCR processing.

Similarly, a workflow application B includes a combination of a PDF operation component 2210 and the email transmission component 2120. The workflow application B is an application that executes a process of sending an email of a result after the PDF operation.

Further, a workflow application C includes a combination of an image conversion component 2310 and a print component 2320. The workflow application C is an application that executes a process of printing a result after image conversion.

The number of components that make up the workflow application is not limited to two. For example, the number and order of the components may be appropriately set according to the process desired by the user, such as inserting an input component in front of each processing components 2110, 2210, 2310, or connecting a plurality of processing components.

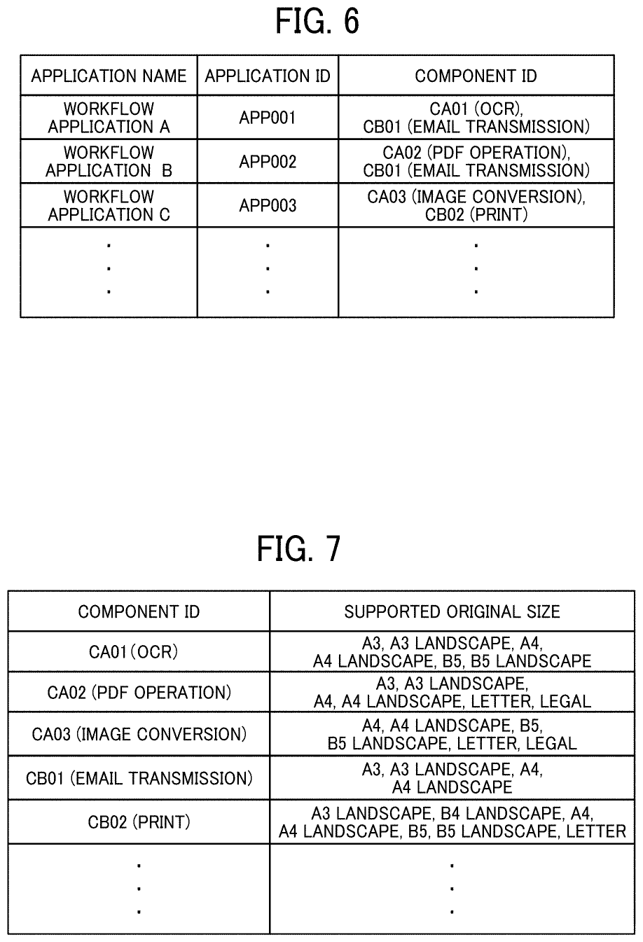

FIG. 6 is a conceptual diagram illustrating an example of an application information management table.

The application information management table is a table for managing application information indicating configurations of workflow application as illustrated in FIG. 5. The storage unit 210 stores the application information management table as illustrated in FIG. 6.

The application information management table stores the application information associating an application name and an application ID for identifying the workflow application, and a component ID for identifying the components included in the workflow application.

For example, the workflow application A is identified by the application ID “APP001”. When the application ID is designated, the component IDs are identified, and the components included in the application are also identified.

FIG. 7 is a conceptual diagram illustrating an example of a component information management table.

The component information management table stores component information indicating each component included in the workflow application as illustrated in FIG. 5. The storage unit 210 stores the component information management table as illustrated in FIG. 7.

The component information management table stores the component information associating a component ID that identifies a component that constitutes the workflow application and a component set value information that indicates a set value that the corresponding component supports. The component set value information is, for example, information on the original size or resolution supported by each component included in the workflow application.

For example, the OCR component having the component ID “CA01” supports A3, A3 landscape, A4, A4 landscape, B5, and B5 landscape with respect to the original size which is an example of the set value information.

Therefore, when the workflow application is selected, the component ID is determined based on the application ID of FIG. 6, and the corresponding component set value information (the original size information in this example) is obtained based on the component ID of FIG. 7. As described above, the workflow application holds the set value information for each component.

Note that the component set value information is not limited to the original size but can be appropriately set such as a print mode (color printing enabled, monochrome printing only, glossy printing enabled, etc.), resolution, or language (supported language type, etc.).

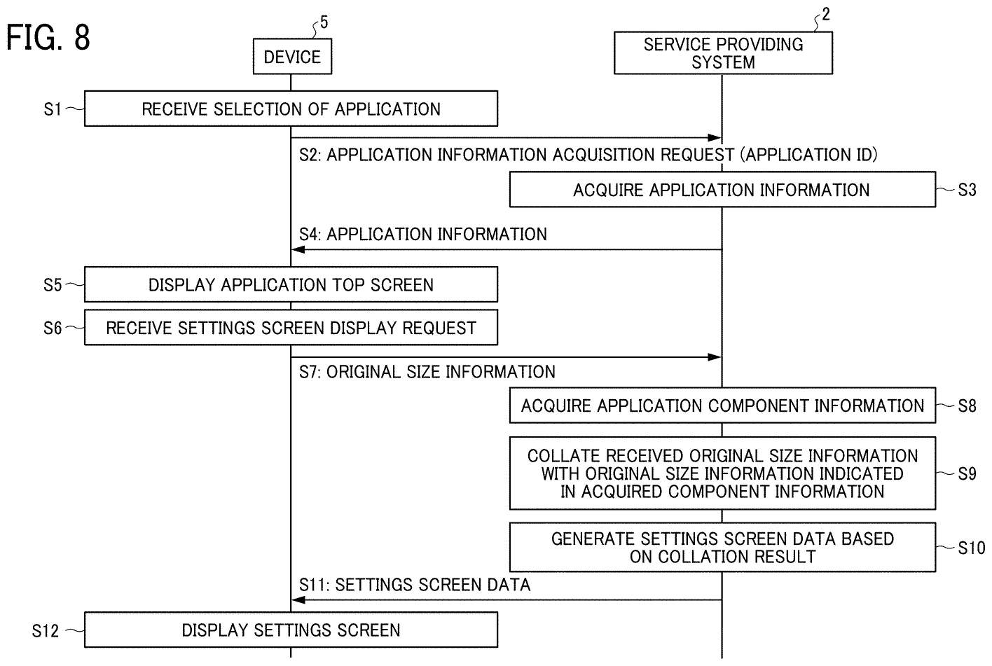

FIG. 8 is a sequence diagram illustrating an example of a display process of the settings screen on the operation panel 51 of the device 5.

In the following description, a sequence is described by taking an OCR document scan process by the workflow application A illustrated in FIG. 5 as an example, but the functions and the set value information can be appropriately replaced depending on the configuration of the application to be used.

The display control unit 509 of the device 5 causes the operation panel 51 to display a list screen of the workflow application (hereinafter referred to as an application) by, for example, an input operation of the user on the operation panel 51. Then, the user selects an application to be used from the list screen displayed on the operation panel 51.

In step S1, in response to the user selecting an application to be used from the list screen displayed on the operation panel 51, the reception unit 511 of the device 5 receives selection of the application.

In step S2, in response to a receiving of a selection of the application by the reception unit 511, the data exchange unit 512 of the device 5 transmits a request for acquiring the application information of the selected application to the service providing system 2. This application information acquisition request includes an application ID that identifies the application selected in step S1. Accordingly, the data exchange unit 212 of the service providing system 2 receives the application information acquisition request transmitted from the device 5.

In step S3, the storing and reading unit 211 of the service providing system 2 searches the application information management table (see FIG. 6) stored in the storage unit 210 using the application ID received in step S2 as a search key, and reads to acquire the application information associated with the same application ID as the received application ID.

In step S4, the data exchange unit 212 of the service providing system 2 transmits the application information acquired in step S3 to the device 5. Accordingly, the data exchange unit 512 of the device 5 receives the application information transmitted from the service providing system 2.

In step S5, the display control unit 509 of the device 5 displays an application top screen corresponding to the application information received in step S4 on the operation panel 51.

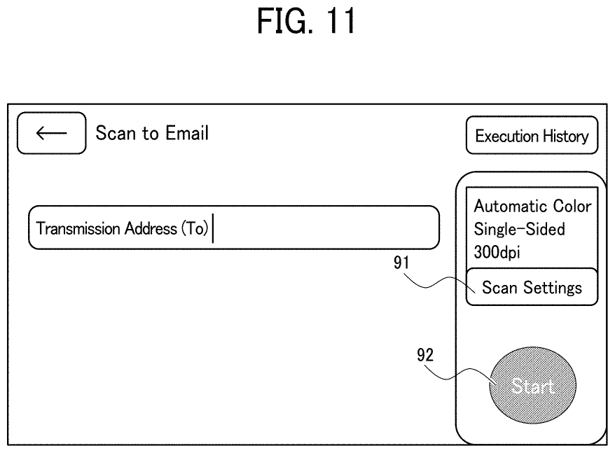

A display example of the application top screen displayed in step S5 is illustrated in FIG. 11 as described below.

In step S6, the reception unit 511 receives a request to display a scan settings screen in response to user's operation to request the display of the scan settings screen of the OCR process on the application top screen displayed on the operation panel 51.

In step S7, the data exchange unit 512 transmits the original size information indicating the original size supported by the device 5 to the service providing system 2. The original size information is an example of the device set value information. Accordingly, the data exchange unit 212 of the service providing system 2 receives the original size information transmitted from the device 5.

In step S8, the storing and reading unit 211 of the service providing system 2 searches the component information management table (see FIG. 7) stored in the storage unit 210 using the component ID included in the application information acquired in step S3 as a search key, and reads to acquire the component information associated with the same component ID as the acquired component ID.

In step S9, the collation unit 213 collates the original size information received in step S7 with the component information acquired in step S8.

Here, the component information acquired in step S8 is the original size supported by each component included in the target application, which is the application selected in step S1.

In step S10, based on the collation result, the screen generation unit 214 generates the settings screen information indicating only the information of the original size supported by both the device 5 and the target application.

In step S11, the data exchange unit 212 of the service providing system 2 transmits the settings screen information generated by the screen generation unit 214 to the device 5. Accordingly, the data exchange unit 512 of the device 5 receives the settings screen information transmitted from the service providing system 2.

In step S12, the display control unit 509 of the device 5 causes the operation panel 51 to display the settings screen based on the settings screen information received in step S11.

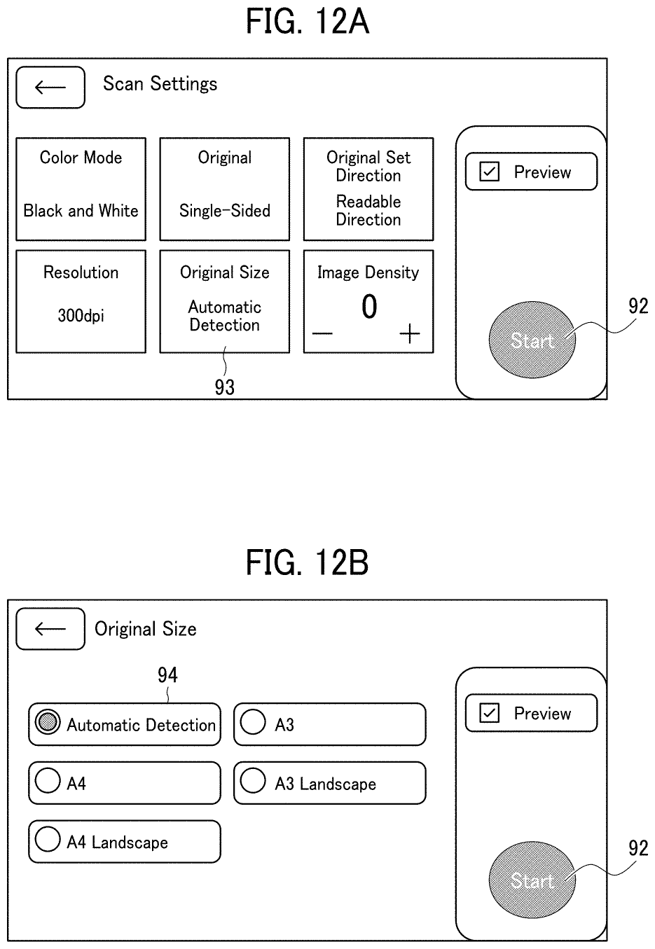

Examples of the settings screens displayed in step S12 is illustrated in FIGS. 12A and 12B as described below.

An example of the processing performed from the collation (step S9) to the settings screen generation (step S10) in the above sequence is described.

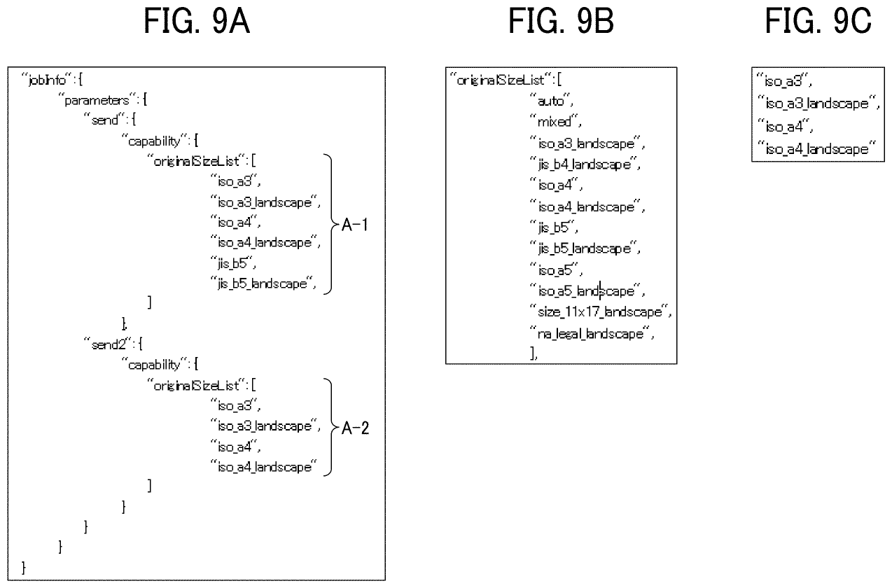

FIGS. 9A, 9B, and 9C are conceptual diagrams illustrating an example of corresponding original size information.

FIGS. 9A, 9B, and 9C illustrate an example in which the set value of the device 5 and the application (component) is the original size. FIG. 9A illustrates the application set value information of the application (workflow application A of FIG. 5), FIG. 9B illustrates the original size information supported by the device 5, and FIG. 9C illustrates the settings screen information.

The application set value information illustrated in FIG. 9A includes information on the original size supported by the components included in the workflow application.

In FIG. 9A, part A-1 indicates the original size supported by the OCR component among the components included in the workflow application A, and part A-2 indicates the original size supported by the email transmission component. This example indicates that the OCR component supports six original sizes (A3, A3 landscape, A4, A4 landscape, B5, B5 landscape), and the email transmission component supports four original sizes.

As described above, even when the appearance is one application, the set value information (specification) may differ between the components. As mentioned above, the workflow application may be developed by combining the components developed in-house and the components developed by a partner, and in such a case, the set value information may not all match.

The original size information illustrated in FIG. 9B indicates the original size supported by the device 5. The original size information is transmitted from the device 5 to the service providing system 2 in step S7 of FIG. 8.

The settings screen information illustrated in FIG. 9C indicates the contents of the settings screen to be displayed on the device 5. The settings screen information is transmitted from the service providing system 2 to the device 5 in step S11 of FIG. 8. The settings screen information illustrated in FIG. 9C indicates the original size included in both the original size supported by the components included in the application set value information of FIG. 9A and the original size supported by the device 5 illustrated in FIG. 9B. In the example of FIG. 9C, four types of original sizes (A3, A3 landscape, A4 and A4 landscape) are indicated.

The collation unit 213 of the service providing system 2 collates the original size (FIG. 9A) supported by the components included in the application with the original size (FIG. 9B) supported by the device 5. Then, the screen generation unit 214 generates the settings screen information (FIG. 9C) indicating the collation result which is the original size supported when the device 5 executes the application.

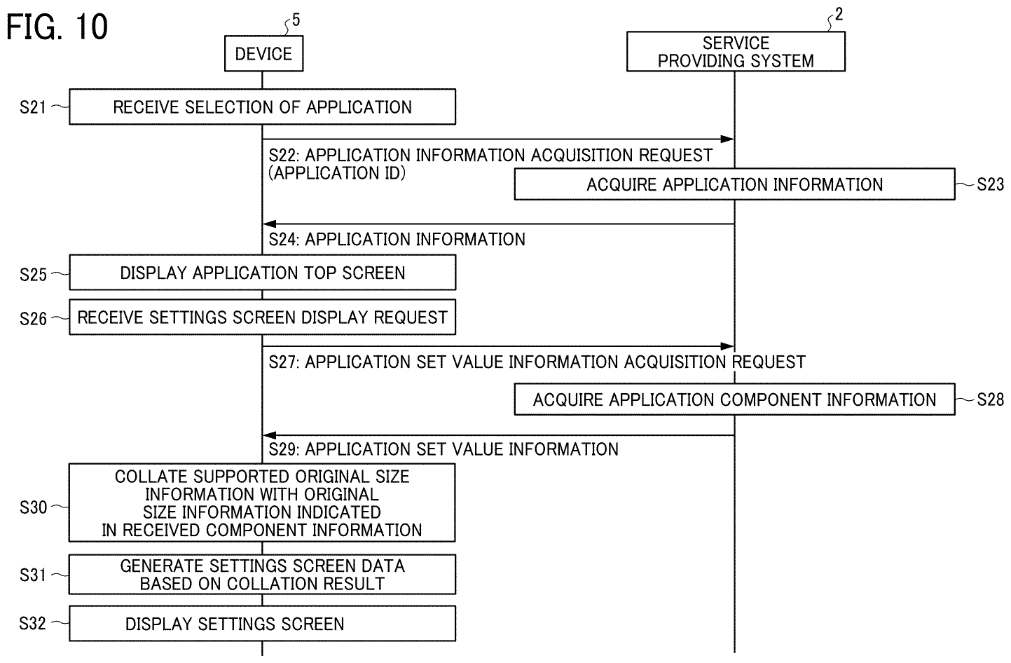

FIG. 10 is a sequence diagram illustrating another example of the display process of the settings screen on the operation panel 51 of the device 5. FIG. 10 illustrates an example in which the device 5 generates screen information for displaying the scan settings screen. Since steps S21 to S26 are sequences equivalent to steps 51 to S6 illustrated in FIG. 8, the description thereof is omitted, and the sequences after step S26 is described below.

In step S27, in response to receiving the display request of the scan settings screen in step S26 by the data exchange unit 512 of the device 5, the data exchange unit 512 transmits the acquisition request for the application set value information to the service providing system 2. Accordingly, the data exchange unit 212 of the service providing system 2 receives the application set value information acquisition request transmitted from the device 5.

In step S28, the storing and reading unit 211 of the service providing system 2 searches the component information management table (see FIG. 7) stored in the storage unit 210 using the component ID included in the application information acquired in step S23 as a search key, and reads to acquire the component information associated with the same component ID as the acquired component ID.

In step S29, the data exchange unit 212 transmits the application set value information including the component information acquired in step S28 to the device 5. Accordingly, the data exchange unit 512 of the device 5 receives the application set value information transmitted from the service providing system 2.

In step S30, the collation unit 513 collates the original size information stored in the storage unit 510 with the component information included in the application set value information received in step S29.

Here, the component information acquired in step S28 is the original size supported by each component included in the target application, which is the application selected in step S21.

In step S31, based on the collation result, the screen generation unit 514 generates a settings screen indicating information of only the original size supported by both the device 5 and the target application.

In step S32, the display control unit 509 of the device 5 displays the settings screen generated in step S31 on the operation panel 51.

Examples of the settings screens displayed in step S32 are illustrated in FIGS. 12A and 12B described below.

FIG. 11 is a diagram illustrating a display example of the application top screen on the operation panel of the device.

This display example illustrates the application top screen displayed on the operation panel 51 of the device 5 in step S5 of FIG. 8 and in step S25 of FIG. 10. The display control unit 509 causes the operation panel 51 to display the application top screen corresponding to the application information transmitted from the service providing system 2.

The application top screen of FIG. 11 is an example of a screen displayed on the operation panel 51 when, for example, application information of an application including a component of email transmission is received from the service providing system 2.

In response to a selection of a scan settings button 91 and pressing of a start button 92 by the user on the application top screen illustrated in FIG. 11, the device 5 receives a display request for the scan settings screen by the reception unit 511.

FIGS. 12A and 12B are diagrams illustrating display examples of the settings screens on the operation panel of the device.

The display examples illustrate the settings screens displayed on the operation panel 51 of the device 5 in step S13 of FIG. 8 and in step S32 of FIG. 10.

FIG. 12A is a display example of the scan settings screen, and FIG. 12B is an original size selection screen displayed when selecting the original size. In response to the user pressing an original size button 93 on the scan settings screen of FIG. 12A, the reception unit 511 receives the selection of the original size button 93 and the display control unit 509 switches the scan settings screen of FIG. 12A to the original size selection screen of FIG. 12B.

The original size displayed on the original size selection screen of FIG. 12B indicates only the original sizes (four types of original sizes in this example) that are supported by both the device 5 and the target application. Therefore, when executing the process in the application, the user may select the original size from the original sizes displayed on the original size selection screen.

Further, since the device 5 displays the original size supported by both the device 5 and the target application and does not display the original size that cannot be used, possibility of the user mistakenly selecting the original size and reselecting the correct size is eliminated.

The original size selection screen of FIG. 12B includes an automatic detection function in addition to the four types of original sizes.

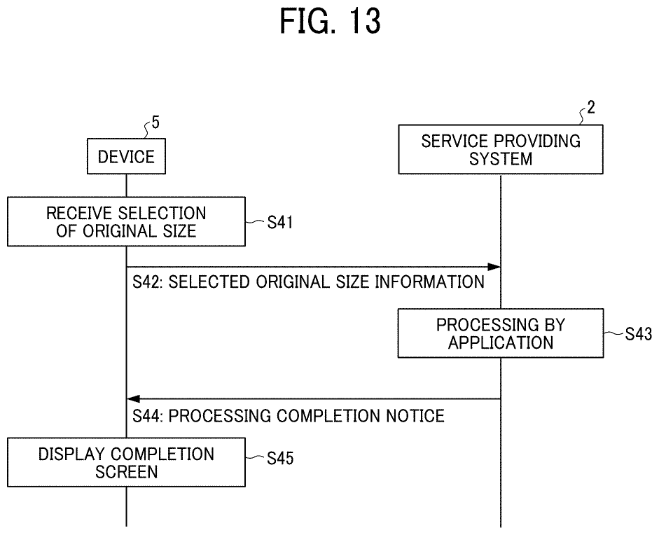

FIG. 13 is a sequence diagram illustrating an example of an application process executed by designating an original size. FIG. 13 illustrates a sequence when the user selects a specific original size and executes the process on the settings screen displayed on the operation panel 51 of the device 5 according to the sequence of FIG. 8 or FIG. 10.

The user selects the original size from the four types of original sizes and presses the start button 92 on the original size selection screen of FIG. 12B.

In step S41, the reception unit 511 of the device 5 receives the selection of the original size.

In step S42, the data exchange unit 512 transmits the original size information selected in step S41 to the service providing system 2. Accordingly, the data exchange unit 212 of the service providing system 2 receives the original size information transmitted from the device 5.

When the user selects the original size and executes the process as described above without selecting the automatic detection function, the original size supported by both the device 5 and the target application is selected. In step S43, the application execution unit 215 of the service providing system 2 executes the processing of the application.

The processing of the application in the present embodiment is the processing in the workflow application A and refers to the process of transmitting an email after OCR process (original scanning).

In step S44, when the processing of the application by the application execution unit 215 is completed, the data exchange unit 212 transmits a processing completion notice to the device 5. As a result, the data exchange unit 512 of the device 5 receives the processing completion notice transmitted from the service providing system 2.

In step S45, the display control unit 509 of the device 5 displays a completion screen on the operation panel 51 indicating that the processing is completed.

The completion screen displayed in step S45 is described below.

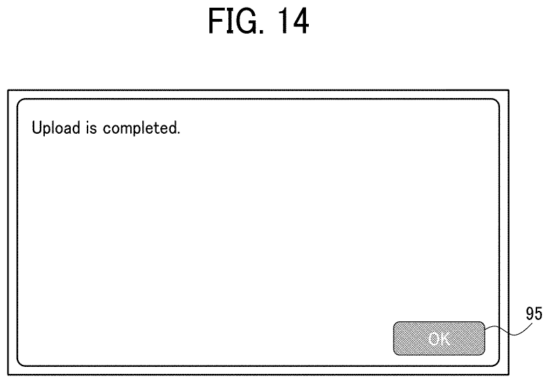

FIG. 14 is a conceptual diagram illustrating a display example of the completion screen on the operation panel of the device.

The display example illustrates the completion screen displayed on the operation panel 51 of the device 5 in step 45 of the sequence described with reference to FIG. 13.

In response to the user pressing the OK button 95 on this screen, the reception unit 511 receives the selection of the OK button 95 and the device 5 turns into a state in which a series of processes in the target application are completed.

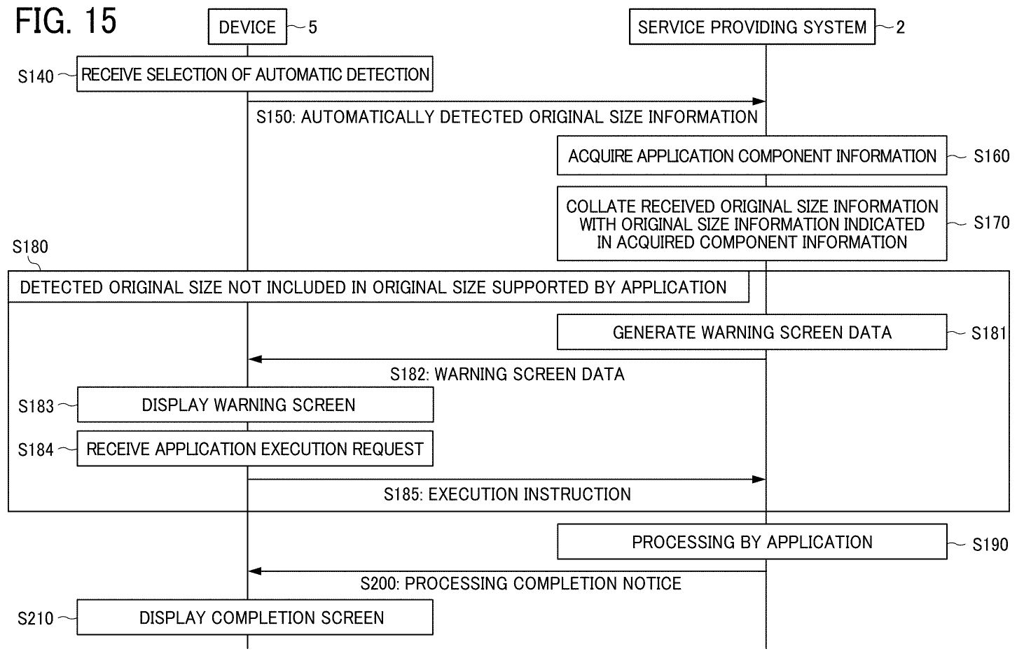

FIG. 15 is a sequence diagram illustrating an example of an application process executed by the automatic detection without designating an original size.

FIG. 15 is a sequence when the user selects the automatic detection function and executes the process on the settings screen (refer to FIG. 12) displayed on the operation panel 51 of the device 5 according to the sequence of FIG. 8 or 10.

This sequence is performed when the user selects the automatic detection button 94 and presses the start button 92 on the original size selection screen of FIG. 12B without selecting any of the four types of original sizes.

In step S140, in response to the user selecting the automatic detection button 94, the reception unit 511 receives the selection of the automatic detection function.

When the reception unit 511 receives the selection of the automatic detection function, the application execution unit 515 of the service providing system 2 detects the original size using the scanner 55 of the device 5. In step S150, the data exchange unit 512 of the device 5 transmits the automatically detected original size information to the service providing system 2. Accordingly, the data exchange unit 212 of the service providing system 2 receives the original size information transmitted from the device 5.

In step S160, the storing and reading unit 211 of the service providing system 2 searches the component information management table (refer to FIG. 7) stored in the storage unit 210 using the component ID included in the application information acquired in step S3 or in step S23 as a search key, and reads and acquires the component information associated with the same component ID as the acquired component ID.

In step S170, the collation unit 213 collates the original size information received in step S150 with the original size information included in the component information acquired in step S160.

In step S190, when the collation unit 213 determines that the original size automatically detected by the device 5 is included in the original size supported by the application, the application execution unit 215 executes the application process.

In step S200, when the processing of the application is completed, the data exchange unit 212 transmits a processing completion notice to the device 5. As a result, the data exchange unit 512 of the device 5 receives the processing completion notice transmitted from the service providing system 2. In step S210, the display control unit 509 displays the completion screen (refer to FIG. 14) on the operation panel 51.

On the other hand, in step 170, when the collation unit 213 determines that the original size automatically detected by the device 5 is not included in the original sizes supported by the application, the process proceeds to step 180.

In step S181, when the collation unit 213 determines that the original size automatically detected by the device 5 is not included in the original sizes supported by the application, the screen generation unit 214 generates warning screen information for displaying a warning screen.

In step S182, the data exchange unit 212 of the service providing system 2 transmits the warning screen information generated by the screen generation unit 214 to the device 5. Accordingly, the data exchange unit 512 of the device 5 receives the warning screen information transmitted from the service providing system 2. In step S183, the display control unit 509 causes the operation panel 51 to display the warning screen based on the warning screen information received in step S182.

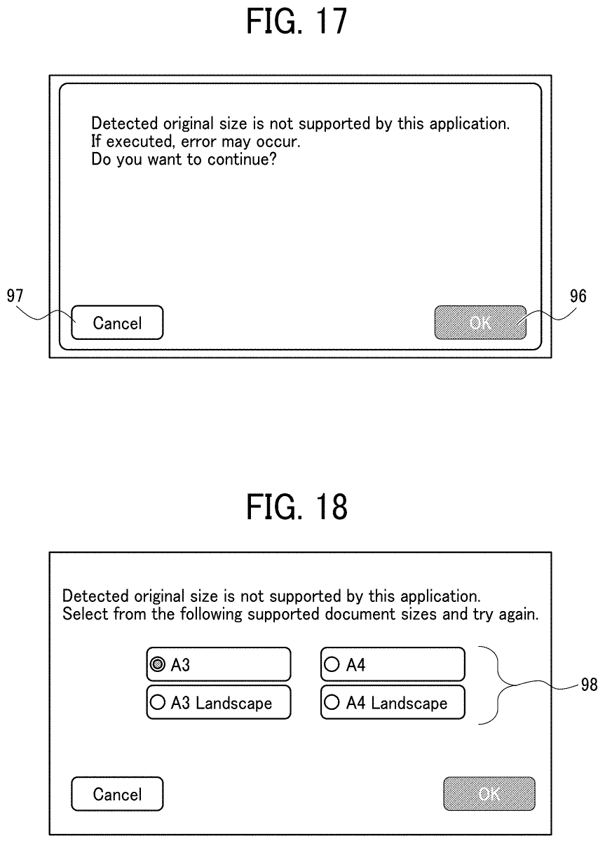

An example of the warning screen displayed in step S183 is illustrated in FIG. 17 as described below.

In step S184, in response to the user pressing the OK button 96 (refer to FIG. 17) on the warning screen displayed on the operation panel 51 after seeing the warning screen in order to continue the process, the reception unit 511 of the device 5 receives an application execution request.

In step S185, in response to receiving the selection of the OK button 96 by the reception unit 511, the data exchange unit 512 transmits an application execution instruction to the service providing system 2. Accordingly, the data exchange unit 212 of the service providing system 2 receives the execution instruction transmitted from the device 5.

In step S190, the application execution unit 215 of the service providing system 2 executes the processing of the application. After that, the process ends after transmitting a processing completion notice in step S200 and displaying a completion screen display in step S210 as described above.

When the user who sees the warning screen selects cancellation, the device 5 sends a cancellation instruction to the service providing system 2, and the process ends without being executed.

In some cases, a set value that cannot be automatically detected, such as a resolution, may be set as a display item on the settings screen.

In such case, the display control unit 509 of the device 5 displays a settings screen indicating only the resolution supported by the device 5 on the operation panel 51, and when the process is executed at a resolution not supported by the application, the display control unit 509 may display the warning screen on the operation panel 51.

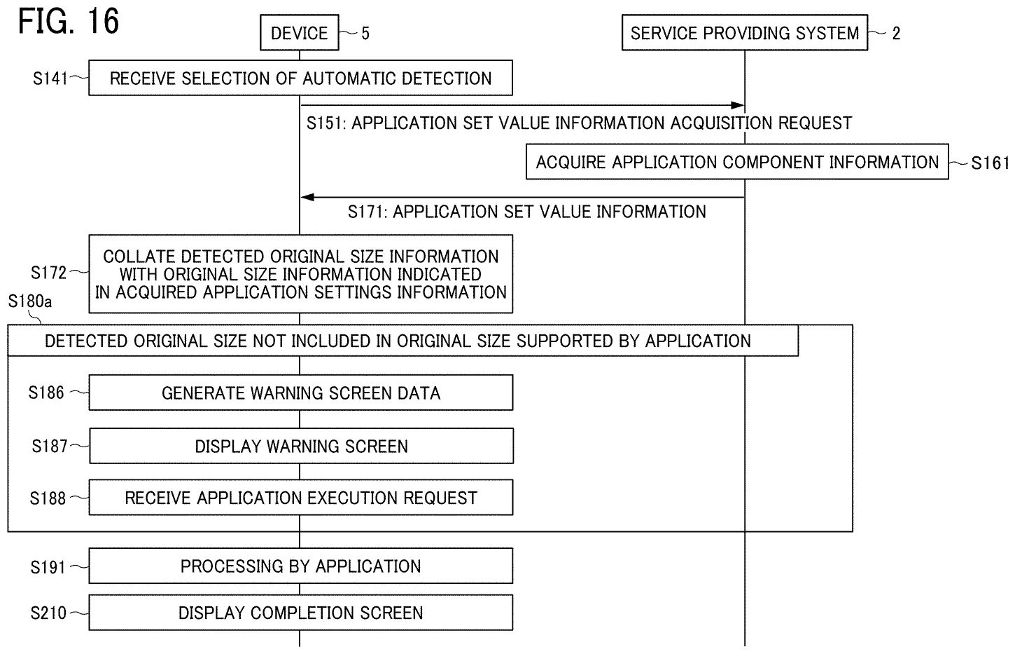

FIG. 16 is a sequence diagram illustrating another example of the application process executed by the automatic detection without designating the original size.

FIG. 16 illustrates an example in which the device 5 generates the warning screen information generates by the service providing system 2 in the process of FIG. 15.

In step S141, the reception unit 511 receives a selection of the automatic detection function in response to the user selecting the automatic detection button 94 without selecting the original size from the four types of original sizes on the original size selection screen of FIG. 12B.

In step S151, the data exchange unit 512 of the device 5 transmits an application set value information acquisition request to the service providing system 2 in response to the reception of the selection of the automatic detection function by the reception unit 511. Accordingly, the data exchange unit 212 of the service providing system 2 receives the application set value information acquisition request transmitted from the device 5.

In step S161, the storing and reading unit 211 of the service providing system 2 searches the component information management table (refer to FIG. 7) stored in the storage unit 210 using the component ID included in the application information acquired in step S3 or in step S23 as a search key, and reads and acquires the component information associated with the same component ID as the acquired component ID.

In step S171, the data exchange unit 212 transmits the application set value information including the component information acquired in step S161 to the device 5. Accordingly, the data exchange unit 512 of the device 5 receives the application set value information transmitted from the service providing system 2.

In step S172, the collation unit 513 collates the automatically detected original size information with the component information (component original size information) included in the application set value information received in step S171.

The automatically detected original size information is acquired by the application execution unit 515 operating the scanner 55 of the device 5. The automatically detected original size information should be acquired by the time the above collation is started.

In step S191, in response to a determination in step S172 by the collation unit 513 that the original size automatically detected by the device 5 is included in the original size supported by the application, the application execution unit 515 executes the application process.

In step S210, the display control unit 509 causes the operation panel 51 to display a completion screen (refer to FIG. 14) indicating that the processing has been completed.

On the other hand, in step S172, when the collation unit 513 determines that the original size automatically detected by the device 5 is not included in the original size supported by the application, the process proceeds to step S180a.

In step S186, in response to a determination by the collation unit 513 that the original size automatically detected by the device 5 is not included in the original size supported by the application, the screen generation unit 514 generates warning screen information for displaying a warning screen.

In step S187, the display control unit 509 causes the operation panel 51 to display the warning screen generated by the screen generation unit 514.

In step S188, the reception unit 511 of the device 5 receives an application execution request in response to the user pressing the OK button 96 (refer to FIG. 17) on the warning screen displayed on the operation panel 51, in order to continue the process after seeing the warning screen.

In step S191, in response to receiving the application execution request by the reception unit 511, the application execution unit 515 executes the processing of the application. In step S210, in response to completion of the processing of the application by the application execution unit 515, the display control unit 509 displays the completion screen (refer to FIG. 14) on the operation panel 51.

In response to a selection of cancellation by the user after seeing the warning screen, the process ends without being executed.

FIG. 17 is a conceptual diagram illustrating a display example of the warning screen on the operation panel of the device.

This display example illustrates the warning screen displayed on the operation panel 51 of the device 5 in step S183 of FIG. 15 and in step S187 of FIG. 16.

In response to the user pressing (selecting) the OK button 96 on the warning screen, the process is executed, and in response to the user pressing (selecting) the cancel button 97 on the warning screen, the process ends without executing the process.

FIG. 18 is a conceptual diagram illustrating another display example of the warning screen on the operation panel of the device.

Although the warning screen of FIG. 17 displays only the warning message, a modification illustrated in FIG. 18 displays a list 98 of the original sizes that can be supported together with the warning message.

The user who sees the warning screen can stop the process by the automatic detection function and select a specific original size and execute the process.

Further, the device 5 may display on the operation panel 51, the original size closest to but larger than the original size automatically detected by the device and may execute the process.

As a result, when the device 5 executes the OCR process, for example, the device 5 executes the process with the original size larger than the original size automatically detected by the device 5, and the original can be read to the end without a part of the original missing.

On the other hand, when processing is executed with a larger original size, useless margin may increase.

In this case, the device 5 may display an option to perform automatic scaling to reduce unnecessary margin, prior to executing the process by the application execution unit 515, for the user to select the option from the operation panel 51 of the device 5.

Further, when the user does not select the automatic scaling, the device 5 may forcibly execute a preview so that the user can check the margin amount from the preview screen displayed on the operation panel 51. Alternatively, the device 5 may display the preview screen on the operation panel 51 when the original size at the execution of process by the application execution unit 515 is changed from the automatically detected original size regardless of whether the automatic scaling is selected.

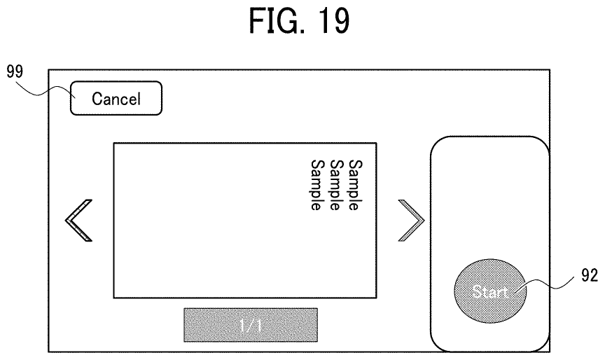

FIG. 19 is a conceptual diagram illustrating an example of the preview screen displayed on the operation panel of the device. The preview screen illustrated in FIG. 19 is displayed on the operation panel 51 by the display control unit 509 when the preview is executed.

The device 5 executes the process in response to the user pressing the start button 92 after confirming the margin amount and the like on the preview screen displayed on the operation panel 51. On the other hand, when the user presses the cancel button 99, the device 5 ends without executing the process.

According to the present disclosure, an information processing apparatus capable of displaying set value supported by the current information processing apparatus with respect to an application used in the information processing apparatus that executes service processing is provided.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

1. An information processing apparatus communicably connected with a server configured to manage applications, the information processing apparatus comprising:
circuitry configured to:
receive a display request for displaying a settings screen to be displayed when executing an application;
transmit to the server, an acquisition request for acquiring set value information of a component included in the application to be executed;
receive the set value information of the component that is transmitted from the server in response to the acquisition request; and
display on a display, the settings screen including a set value compatible with the application executing in the information processing apparatus, the set value being determined based on the set value information of the information processing apparatus and the set value information of the component.

2. The information processing apparatus of claim 1, wherein the circuitry is further configured to:
collate the set value information of the information processing apparatus with the set value information of the application;
generate the settings screen including a set value compatible with the application executing in the information processing apparatus based on a collation result; and
cause the application to execute a process in response to an input received via the settings screen.

3. The information processing apparatus of claim 1, wherein
the application includes a plurality of components, and the application holds set value information for each of the plurality of components.

4. The information processing apparatus of claim 2, wherein the circuitry is further configured to:
generate, as the settings screen, a settings screen including the set value supported by both the information processing apparatus and the application, and information indicating that an automatic detection function of the information processing apparatus is effective;
enable processing by the automatic detection function to be executed in the processing by the application; and
display on the display, a warning screen when there is no set value supported by both the information processing apparatus and the application.

5. The information processing apparatus of claim 4, wherein
the warning screen includes a warning message and the set value supported by both the information processing apparatus and the application.

6. The information processing apparatus of claim 2, wherein the circuitry is further configured to:
generate, as the settings screen, a settings screen including the set value supported by both the information processing apparatus and the application, and information indicating that the automatic detection function of the information processing apparatus is effective; and
enable the processing by the automatic detection function in the processing by the application,
wherein when there is no set value supported by both the information processing apparatus and the application, the circuitry executes the processing using the set value closest and larger than a desired set value.

7. The information processing apparatus of claim 2, wherein the circuitry is further configured to:
generate, as the settings screen, a settings screen including the set value supported by both the information processing apparatus and the application, and information indicating that the automatic detection function of the information processing apparatus is effective; and
enable the processing by the automatic detection function in the processing by the application,
wherein when there is no set value supported by both the information processing apparatus and the application, the circuitry executes the processing magnifying the set value automatically detected by the information processing apparatus.

8. The information processing apparatus of claim 2, wherein the circuitry is further configured to:
generate, as the settings screen, a settings screen including the set value supported by both the information processing apparatus and the application, and information indicating that the automatic detection function of the information processing apparatus is effective; and
enable the processing by the automatic detection function in the processing by the application,
wherein, when there is no set value supported by both the information processing apparatus and the application, the circuitry displays a preview screen on the display.

9. A system comprising circuitry configured to:
collate set value information of an information processing apparatus with set value information of a component included in an application to be executed by the information processing apparatus, the application being provided from a server communicably connected with the information processing apparatus;
generate a settings screen including a set value compatible with the application executing in the information processing apparatus based on a collation result; and
display the settings screen on a display.

10. The system of claim 9, wherein
the application includes a plurality of components, and the application holds the set value information for each of the plurality of components.

11. A method of displaying, performed by an information processing apparatus communicably connected with a server configured to manage an application, the method comprising:
receiving a display request for displaying a settings screen to be displayed when executing an application;
transmitting to the server, an acquisition request for acquiring set value information of a component included in the application to be executed;
receiving the set value information of the component that is transmitted from the server in response to the acquisition request; and
displaying the settings screen including a set value compatible with the application executing in the information processing apparatus, the set value being determined based on set value information of the information processing apparatus and the set value information of the component.

12. The method of claim 11, wherein
the application includes a plurality of components, and the application holds the set value information for each of the plurality of components.
